(19) United States
(12) Patent Application Publication
(10) Pub. No.: US 2013/0093107 A1
(43) Pub. Date: Apr. 18, 2013

(54) Fish and Game Washer

(71) Applicant: Roland Funderburg, Abilene, TX (US)

(72) Inventor: Roland Funderburg, Abilene, TX (US)

(21) Appl. No.: 13/585,229

(22) Filed: Oct. 11, 2012

Related U.S. Application Data
(60) Provisional application No. 61/547,587, filed on Oct. 14, 2011.

(51) Int. Cl. A22C 25/02; B08B 3/02

(52) U.S. Cl. CPC A22C 25/02; B08B 3/02
USPC 261/121.1; 134/198; 452/173

(57) ABSTRACT

It is designed to wash and clean meat. When meat is put in a 5 gallon bucket and water source connected and turned on. Air is sucked in to mix with water. This makes the meat float up from the bottom and begin to toss and tumble, which takes loose scales, feathers, blood and debris over the top of bucket. This leaves the meat clean in 5 to 15 minutes, depending on the load. Therefore you don't have to mess up kitchen sink. It is good for washing other things, including fruits in vegetables.

### BRIEF DESCRIPTION OF INVENTION

Washes and cleans fish and game.

### DESCRIBE THE PROBLEM THE INVENTION SOLVES

When meat is put in bucket, the air bubbles making the meat toss and tumble and swirl in water.

### HOW DOES INVENTION SOLVE THE PROBLEM

My invention takes the loose feathers off of game birds (dove, quail, etc.) and loose hair of off squirrels and rabbits. Removes loose scales off of fish. Also removes some grease plus debris and blood in five to fifteen minutes.

### IS THE INVENTION AN IMPROVEMENT OVER WHAT CURRENTLY EXISTS?

Yes, have never seen one.

### PARTS OF COMPONENTS OF THE INVENTION

Please refer to the drawings at the end of this example for a key to the reference numbers.

| Reference Numbers | Name of Part |
|---|---|
| 2 | Fish and game washer |
| 4 | Jet and nozzle |
| 6 | Water hose connection |
| 8 | 45 degree connector |
| 10 | Connector |
| 12 | Air sucking device |
| 14 | Water supply |
| 16 | Bucket container |
| 18 | Gasket |
| 20 | Control valve |
| 22 | Hose |
| 24 | Scrubber |
| 26 | Scrubber cover |

### Number 2 (Fish and Game Washer)

It is designed to force water through nozzle. Water/air nozzle can be made up of plastic, iron, brass, aluminum, stainless steel. I am using plastic ½ inch with Number 10 (connector) being a ¾ inch female screwed through a Number 16 (5 gallon bucket or container) with ¾ inch hole in it. With Number 18 (gasket) Number 8 (45 degree connector) ¾ inch male screwed on to Number 10 (connector) ¾ inch female. The length of this is 7 inches long, could be made shorter, longer or of different sizes.

### Number 4 (Jet and Nozzle)

It can be made of plastic, stainless steel, brass, nylon. It can be made permanent or changeable. I am using 13/64 inch in first jet and second jet ⅜ inch, could be used bigger smaller.

1^{st} jet Number 4 (jet and nozzle) is 13/64 inch to reduce jet water flow for Number 2 (fish and game washer). Nozzle Number 12 (air sucking device) is used to suck air in and mixes with water.

2^{nd} jet Number 4 (jet and nozzle) is larger in size, ⅜ inch. Then water and air are forced through second jet. When this is tied into Number 16 (five gallon bucket or container) with Number 8 (45 degree connector) being turned to the side, this makes water swirl. The bubbles make the meat tumble and swirl.

### Number 6 (Water Hose Connection)

Water source can be city water or any water source, will need 60 lbs. psi, more or less and could be used with valve to control.

### Number 8 (45 Degree Connector)

¾ inch male screwed on with 45 degree nipple, more or less.

### Number 10 (Connector)

¾ inch female screw on to Number 8 (45 degree connector) ¾ inch male, these could be reversed and then could be made with flanges and bolted together in Number 16 (bucket or container) with Number 2 (fish and game washer) a quick connect tied into Number 10 (connector), with quick connect these could be made larger or smaller in size and of different material, plastic, brass, stainless steel, or nylon.

### Number 12 (Air Sucking)

Opening into water jet, flowing through Number 4 (jet and nozzle) will suck air in and mix with water. I am using ½ inch, this could be made bigger or smaller. It can be used to suck fluids, can be used with 20 (control valve) or Number 2 (fish and game washer). Number 2 can be used as a power washer or chemical sprayer.

### Number 14 (Water Supply)

From home city water or any source, needs to be 60 lbs. more or less.

### Number 16 (Bucket or Container)

Number 2 (fish and game washer) could be tied into different sizes of containers. I am using 5 gallons plastic bucket. Also Number 2 (fish and game washer) could be clamped inside of bucket or container.

### Number 18 (Gasket)

It can be used between Number 10 (connector) and Number 16 (bucket or container).

### Number 20 (Control Valve)

It can be designed to fit Number 2 (fish and game washer) where Number 12 (air sucking) would control how much fluid Number 22 (hose) holds. This could be pushed on or screwed on. It can also be made into Number 2 (fish and game washer) to slide on and off to control Number 12 (air sucking).

### Number 22 (⅜ Inch Hose)

This could be bigger or smaller and could be plastic or rubber. Number 12 (air sucking) controlled air sucking in the Number 20 (control valve) with control valve. Would control how much fluid number 22 holds.

### Number 24 (Scrubber)

Could be screwed on or pushed on to Number 8 (45 degree connector). It can be made in different sizes and shapes (4″×4″ square, round or longer in length).

### Number 26 (Scrubber Cover)

It can be made of different materials (sponge, cloth, etc.) When using this as a washer for car, house, windows, etc. Soap can be squirted into Number 12 (air sucking) as desired.

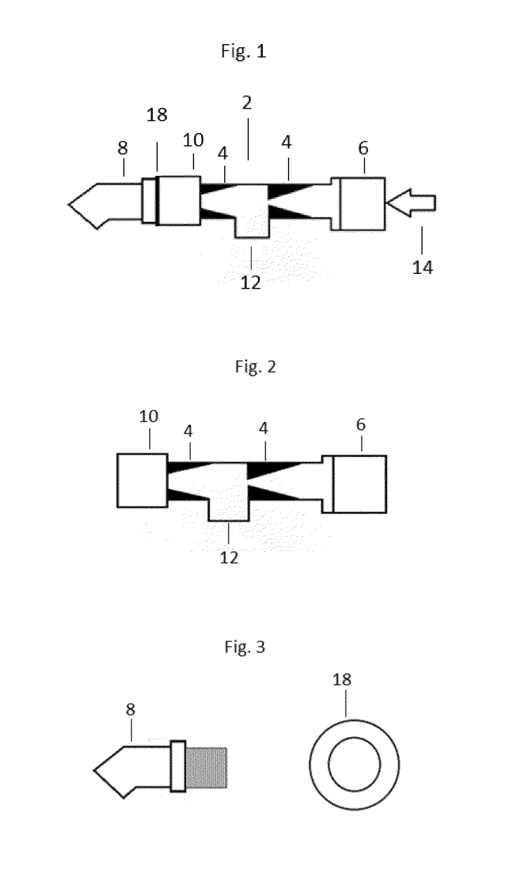

FIG. 1: Fish and game washer complete with all parts

FIG. 2: Fish and game washer without 45 degree connector and gaskets connected

FIG. 3: 45 degree connector and gasket

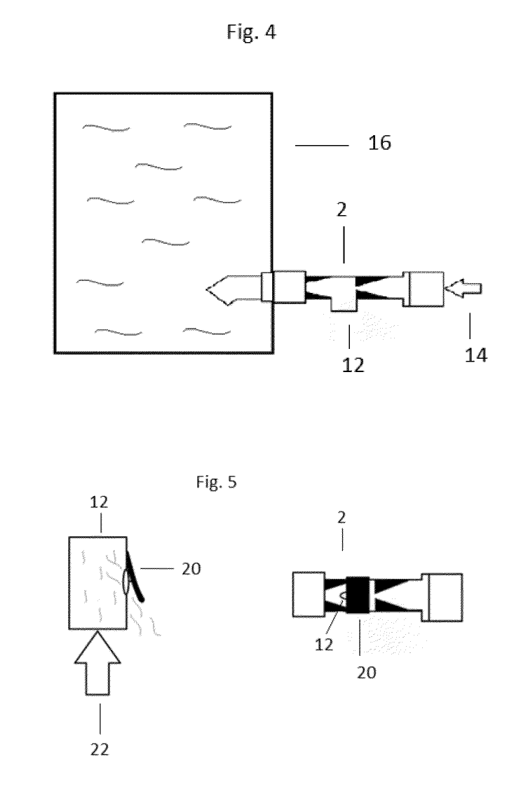

FIG. 4: Fish and game washer installed into a 5 gallon bucket

FIG. 5: Optional control valves to control amount of air suction.

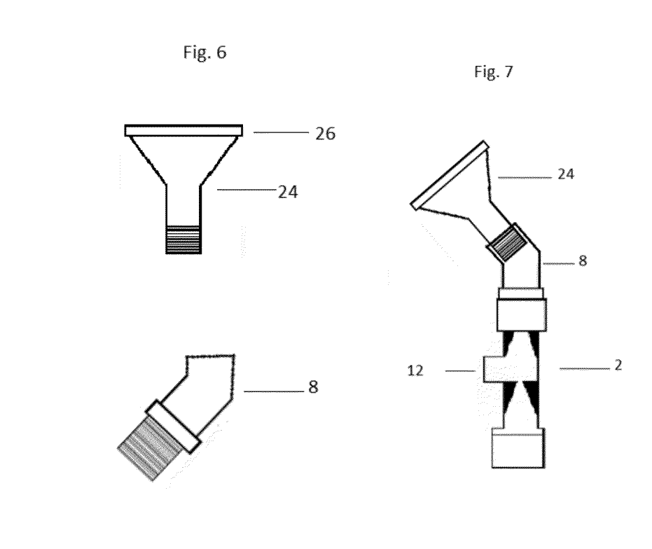

FIG. 6: Optional scrubber with 45 degree connector

FIG. 7: Optional scrubber installed with 45 degree connector into washer.

1. It will wash fish and game more effectively and faster.

2. It can be used as a power washer, with or without soap.

3. It may also be used as an aerator to keep fish alive.

4. It can be used to wash other things like vegetables.
